(19) United States
(12) Patent Application Publication
(10) Pub. No.: US 2025/0076860 A1
(43) Pub. Date: Mar. 6, 2025

(54) NON-DESTRUCTIVE TESTING INSPECTION SYSTEM

(71) Applicant: SAUDI ARABIAN OIL COMPANY, Dhahran (SA)

(72) Inventors: Majed F. Rajeh, Riyadh (SA); Saud S. Al-Otaibi, Riyadh (SA); Soliman A. Al-Walaie, Dammam (SA); Isa H. Al-Mudaibegh, Dammam (SA); Meshari S. Al-Otaibi, Dhahran (SA)

(73) Assignee: SAUDI ARABIAN OIL COMPANY, Dhahran (SA)

(21) Appl. No.: 18/459,194

(22) Filed: Aug. 31, 2023

(51) Int. Cl. G05B 19/418

(52) U.S. Cl. CPC G05B 19/41875; G05B 19/4183; G05B 19/41865

(57) ABSTRACT

A method to perform a nondestructive test (NDT) is disclosed. The method includes obtaining, by a centralized analysis system, baseline data and a checklist of the NDT to be performed for a component at an NDT site of an industrial facility, where the baseline data includes target parameters of the NDT and the checklist includes process steps of the NDT, capturing, by an NDT inspection device disposed at the NDT site, physical parameters of the NDT while each process step of the NDT is performed, transmitting, by the NDT inspection device to the centralized analysis system, the physical parameters of the NDT, analyzing, by the centralized analysis system, the physical parameters of the NDT with respect to the baseline data and the checklist, and generating, in response to said analyzing by the centralized analysis system, an NDT verification result.

### BACKGROUND

Oil and gas facilities require frequent inspection to ensure integrity of equipment structures, such as pipelines or pressure vessels. The integrity of pipelines or pressure vessels relates to pipe leaks, pipe weld defects, pipe failures, pipeline drag reduction, etc.

Nondestructive testing (NDT) is a testing procedure for inspecting and evaluating materials, components, or assemblies without destroying their serviceability. Common test methods for performing NDT include Penetrant Testing (PT), Magnetic Particle Testing (MT), Radiographic Testing (RT), Ultrasonic Testing (UT), Positive Material Identification (PMI), etc. During NDT, technicians identify cracks, voids, inclusions, and weld discontinuities, as well as identify misassembled subcomponents. NDT is generally performed to ensure product integrity and reliability, control manufacturing processes, lower production costs, and maintain a uniform quality level. Industries that utilize NDT include aerospace, manufacturing, energy (oil and gas, nuclear), chemical, infrastructure (bridges, highways, buildings), transportation (automotive, railways), maritime, construction industries, etc. In particular, NDT prevents catastrophic failures such as pipeline leaks and explosions, nuclear reactor failures, airplane and locomotive crashes, and ships sinking. One of the important limitations in conventional NDT is that the process is performed manually and susceptible to human error.

### SUMMARY

In general, in one aspect, the invention relates to a method to perform a nondestructive test (NDT) of an industrial facility. The method includes obtaining, by a centralized analysis system, baseline data and a checklist of the NDT to be performed for a component at an NDT site of the industrial facility, wherein the baseline data comprises target parameters of the NDT, wherein the checklist comprises process steps of the NDT, capturing, by an NDT inspection device disposed at the NDT site, physical parameters of the NDT while each of the process steps of the NDT is performed, transmitting, by the NDT inspection device to the centralized analysis system, the physical parameters of the NDT, analyzing, by the centralized analysis system, the physical parameters of the NDT with respect to the baseline data and the checklist of the NDT, and generating, in response to said analyzing by the centralized analysis system, an NDT verification result.

In general, in one aspect, the invention relates to a nondestructive test (NDT) inspection device for performing an NDT of an industrial facility. The NDT inspection device includes a plurality of sensors that capture physical parameters of the NDT while each of process steps of the NDT is performed for a component at an NDT site of the industrial facility, an NDT interface that controls and records NDT testing parameters of the NDT, wherein the NDT interface comprises a GPS tool for locating the NDT site and a data communication module for transmitting the captured physical parameters of the NDT to a centralized analysis system of the industrial facility, and a display screen that displays the captured physical parameters, a checklist of the NDT, NDT results, GPS information of the NDT site, and a function menu that allows a user to view and check off each of the process steps of the checklist, initiate NDT information recording, and display recorded NDT information, wherein the centralized analysis system obtains baseline data and the checklist of the NDT, wherein the baseline data comprises target parameters of the NDT, wherein the checklist comprises the process steps of the NDT, analyzes the physical parameters of the NDT with respect to the baseline data and the checklist of the NDT, and generates, in response to analyzing the physical parameters of the NDT, an NDT verification result.

In general, in one aspect, the invention relates to a nondestructive test (NDT) inspection system for performing an NDT of an industrial facility. The NDT inspection system includes an NDT inspection device comprising a plurality of sensors that capture physical parameters of the NDT while each of process steps of the NDT is performed for a component at an NDT site of the industrial facility, an NDT interface that controls and records NDT testing parameters of the NDT, wherein the NDT interface comprises a GPS tool for locating the NDT site and a data communication module for transmitting the captured physical parameters of the NDT to a centralized analysis system of the industrial facility, and a display screen that displays the captured physical parameters, a checklist of the NDT, NDT results, GPS information of the NDT site, and a function menu that allows a user to view and check off each of the process steps of the checklist, initiate NDT information recording, and display recorded NDT information, and a centralized analysis system that obtains baseline data and the checklist of the NDT, wherein the baseline data comprises target parameters of the NDT, wherein the checklist comprises the process steps of the NDT, analyzes the physical parameters of the NDT with respect to the baseline data and the checklist of the NDT, and generates, in response to analyzing the physical parameters of the NDT, an NDT verification result.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1D show systems in accordance with one or more embodiments.

FIG. 2 shows a method flowchart in accordance with one or more embodiments.

FIGS. 3A-3B show an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and system for performing nondestructive testing (NDT) using an intelligent NDT inspection system. In particular, the intelligent NDT inspection system includes an intelligent artificial intelligence (AI)-powered device with built-in data of approved NDT checklist/process/steps that transforms conventional and manual NDT inspection methods into an automatically verified and validated process. In one or more embodiments of the invention, AI algorithms, advanced sensors, instruments and digital processes are utilized to inspect and verify that actual NDT activities have been completed correctly where the inspection/verification does not impact the actual NDT activities. Accordingly, the conventional and manual NDT inspection/verification is converted into a digital process by using the AI-powered device to record the NDT activities as digital photos and videos based on the built-in approved checklist/process/steps and controlled by automated parameters of time, durations, and location that can be verified at any subsequent time.

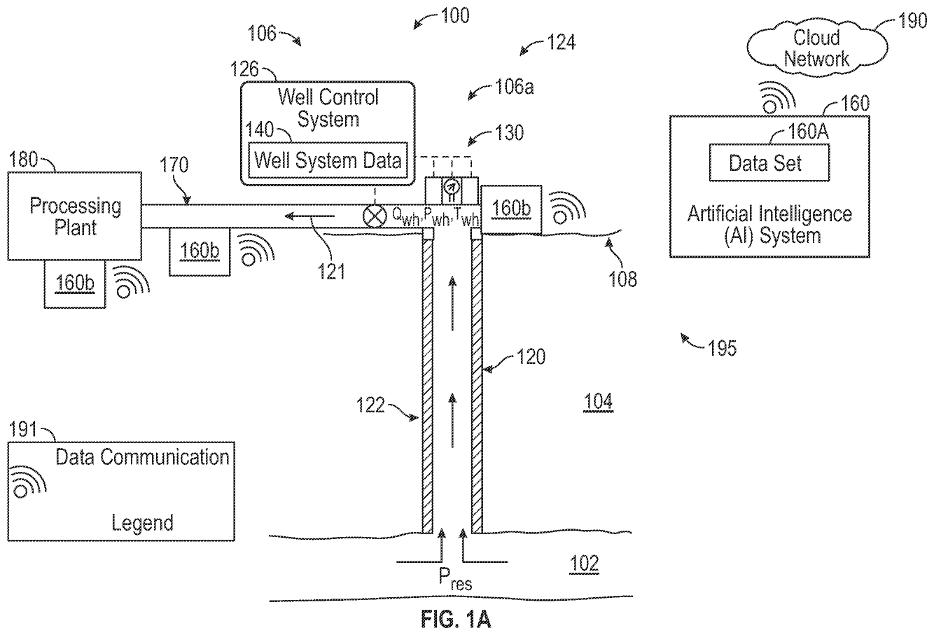

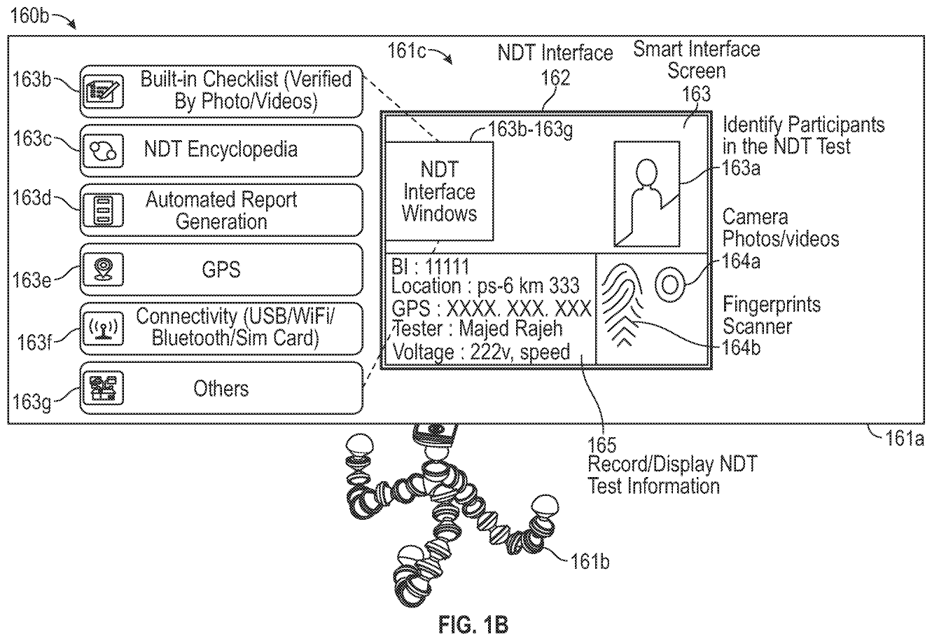

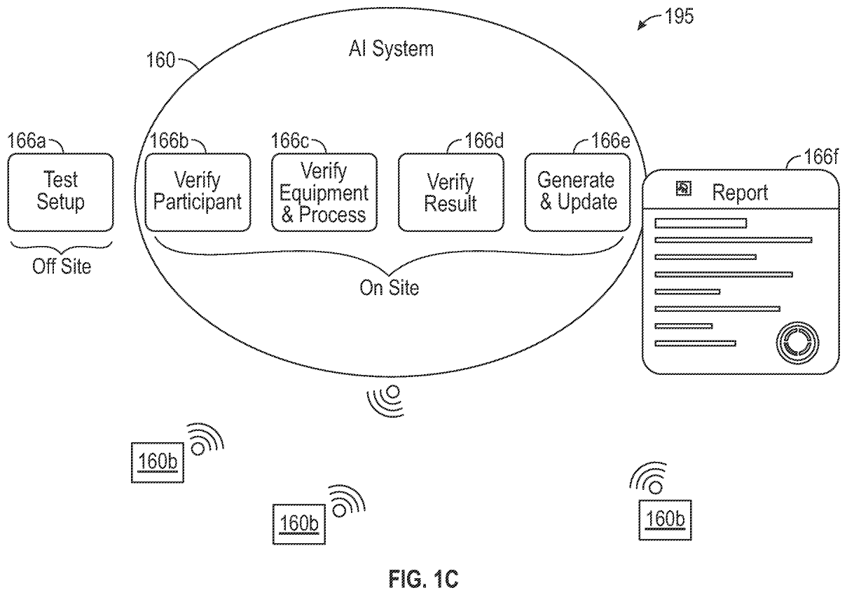

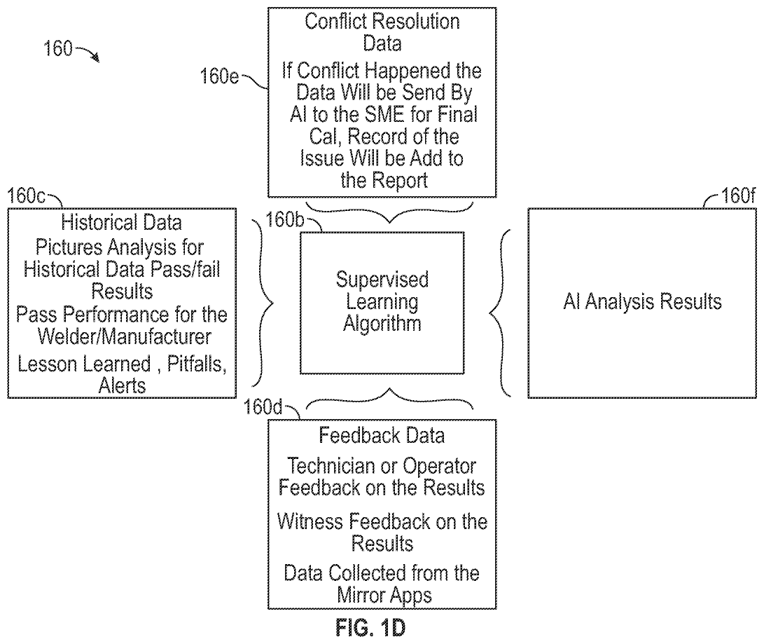

FIG. 1A shows a schematic diagram in accordance with one or more embodiments. As shown, FIG. 1A illustrates an oil and gas environment (100) that includes a hydrocarbon reservoir (“reservoir”) (102) located in a subsurface hydrocarbon-bearing formation (“formation”) (104), a well system (106), and a processing plant (180). The area where the well system (106) is located is referred to as a wellsite (106a). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). The well system (106) may be part of a production system that further includes a pipeline network (170) and a processing plant (180) for transporting and processing the hydrocarbons, i.e., production from the reservoir (102). In one or more embodiments, the processing plant (180) is an industrial process plant such as an oil/petroleum refinery where petroleum (crude oil) is transformed and refined, or other types of chemical processing plants. The processing plant (180) typically includes large, sprawling industrial complexes with extensive piping network running throughout, carrying streams or liquids between large chemical processing units, such as distillation columns. The well system (106), pipeline network (170), and processing plant (180) require frequent inspection (e.g., NDT) in order to ensure the asset integrity of the structure and safe work practices.

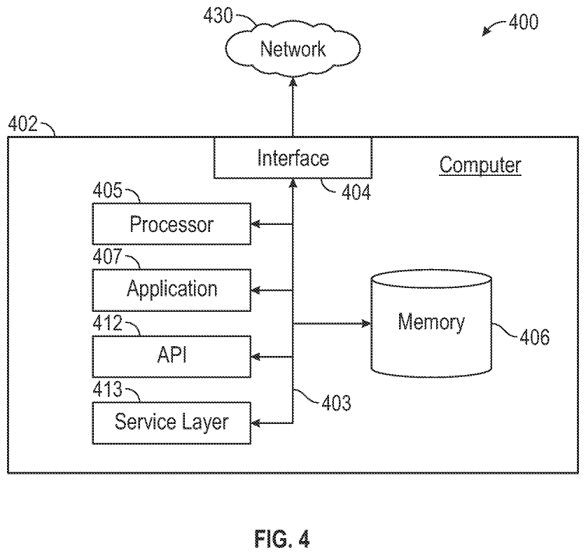

In some embodiments, the well system (106) includes a wellbore (120), a well sub-surface system (122), a well surface system (124), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system that is similar to the computing system (400) described below with regard to FIG. 4 and the accompanying description.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein.

In some embodiments, the well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing.

In some embodiments, during operation of the well system (106), the control system (126) collects and records well system data (140) for the well system (106). The well system data (140) may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well system (106), and water cut data. The well system data (140) may further include monitoring data of equipment structures at the wellsite (106a). Throughout this disclosure, the term “equipment structure” refers to mechanical structures of equipment and piping network. In some embodiments, the measurements and monitoring data are recorded in real-time, and are available for review or use within seconds, minutes or hours of the condition being sensed (e.g., the measurements are available within 1 hour of the condition being sensed). In such an embodiment, the well system data (140) may be referred to as “real-time” well system data (140). Real-time well system data (140) may enable an operator of the well (106) to assess a relatively current state of the well system (106) and make real-time decisions regarding development and maintenance of the well system (106) and the reservoir (102), such as on-demand adjustments in regulation of production flow from the well or preventive maintenance of equipment structures to prevent disruption to the production flow from the well. A database of recorded well system data (140), including but not limited to monitoring data, may be interrogated using machine learning (ML) and artificial intelligence (AI) techniques to identify continuous process improvement. For example, the quality of pipelines may be monitored and analyzed over a time period, or the deterioration of a pipe may be identified over time to enable proactive maintenance or repair.

In one or more embodiments, a data set (160a) is generated by at least combining the recorded well system data (140), including but not limited to monitoring data, and cumulative records of repair and replacement of equipment structure throughout a region of interest. For example, the region of interest may be a field having multiple wellsites (e.g., wellsite (106a)), processing plants (e.g., processing plant (180)), and pipeline networks (e.g., pipeline network (170)). In another example, the region of interest may be a portion of the field, a portion of a wellsite (e.g., wellsite (106a)), a portion of a processing plant (e.g., processing plant (180)), or a portion of a pipeline network (e.g., pipeline network (170)). Accordingly, a machine learning algorithm for the maintenance operation of the region of interest is trained based on the data set (160a). The machine learning algorithm is used by an artificial intelligent (AI) system (160) of a non-destructive testing (NDT) inspection system (195) to generate maintenance notices to facilitate the maintenance operation of the region of interest. The machine learning algorithm used includes supervised learning with inputs of (i) picture analysis from historical data (pass/fail) results, (ii) operator and equipment performance, (iii) lesson learned, (iv) technician/operator feedback, (v) SME (subject matter expert) feedback, and (vi) collected data from the mirror application, which is a software application installed on a user device of an NDT witness or supervisor to monitor and collect additional data for the NDT inspection system. Additional details of the supervised learning is described in reference to FIG. 1C below.

In some embodiments, the NDT inspection system (195) is deployed in the oil and gas environment (100) and may include hardware and/or software with functionality for automating NDT inspections to facilitate operations of the well system (106), such as a preventive maintenance of the pipe line or other equipment structures. For example, the NDT inspection system (195) may include the AI system (160), the data set (160a), and AI-powered NDT inspection devices (160b) deployed throughout inspection points or locations of the oil and gas environment (100). The AI system (160) is a centralized analysis system that includes hardware and software components for performing NDT monitoring and verification based on AI algorithms. The NDT inspection devices (160b) are distributed devices disposed at NDT sites and communicably coupled to the AI system (160). Throughout this disclosure, the term “NDT site” refers to a location within the oil and gas environment (100) where an NDT is performed or to be performed for a component (referred to as the component-under-test or equipment-under-test) of the oil and gas environment (100). For example, the component-under-test may include pipelines, pressure vessels, or other equipment. In some embodiments, a single AI system (160) monitors and verifies multiple NDTs contemporaneously performed at different NDT sites using multiple NDT inspection devices (160b). In some embodiments, a single AI system (160) monitors and verifies multiple NDTs successively performed at different NDT sites using a single NDT inspection device (160b).

The components of the NDT inspection system (195) collectively transform conventional & manual NDT inspection process into a fully digital, automated and integrated process. The fully digital, automated and integrated NDT inspection process adopts AI techniques, advanced sensors, instruments and digital process to verify that the actual NDT activities (i.e., each process step specified in the NDT checklist) are completed correctly where the verification does not impact the actual NDT activities. The NDT verification results of the NDT inspection devices (160b) include proof of completion of NDT, proof of operator conducting the NDT, proof of NDT result, and proof of the time and location of NDT activities. For example, the AI system monitors the time between one step to the next and over the locations of each step by the GPS and the other mirror applications on the user devices. In one or more embodiments, the NDT verification results are digitalized to mitigate forgery attempts and ensure that the actual NDT will not be changed or affected.

In some embodiments, the NDT inspection system (195) is implemented using cloud networking, which is a type of information technology (IT) infrastructure in which some or all of an organization's network capabilities and resources are hosted in a public or private network. For example, the organization may be the operation entity of the oil and gas environment (100). These network resources may include virtual routers, firewalls, and bandwidth and network management software, with other tools and functions collectively referred to as the cloud network (190), which is managed in-house or by a service provider, and available on demand. For example, the computing services used by the AI system (160) may include servers, storage, databases, networking, software, analytics, and intelligence delivered on demand via the cloud network (190).

While the AI system (160) is shown as associated with a well site, embodiments are contemplated where at least a portion of the AI system (160) is located away from well sites and coupled to the NDT inspection devices (160b) remotely via the cloud platform (190). The coupling between the AI system (160) and NDT inspection devices (160b) may be based on wired and/or wireless data communications (denoted as the data communication icons according to the legend (191)) suitable for accessing the cloud platform (190). While the NDT inspection system (195) is shown as deployed in the oil and gas environment (100), embodiments are contemplated where a similar NDT inspection system is deployed in other industrial environments, such as aerospace, manufacturing, nuclear energy, chemical, infrastructure (bridges, highways, buildings), transportation (automotive, railways), maritime, construction industries, etc. In some embodiments, the AI system (160) and NDT inspection devices (160b) of the NDT inspection system (195) may include a computer system that is similar to the computing system (400) described below with regard to FIG. 4 and the accompanying description.

FIG. 1B illustrates a block diagram of an example of an AI-powered NDT inspection device (160b) depicted in FIG. 1A. In one or more embodiments, one or more of the modules and/or elements shown in FIG. 1B may be omitted, repeated, combined and/or substituted. Accordingly, embodiments disclosed herein should not be considered limited to the specific arrangements of modules and/or elements shown in FIG. 1B.

As shown in FIG. 1B, the example NDT inspection device (160b) includes a casing (161a), a holder (161b), and an electronic assembly (161c). The casing (161a) is an explosion-proof and shockproof enclosure. Magnetic strips may be permanently or removably attached to the casing (161a) such that the NDT inspection device (160b) can be magnetically mounted to a metal surface for taking photos and videos during the NDT. The holder (161b) is a flexible tripod stand to position the NDT inspection device (160b) on different surface elevations. For example, the legs of the tripod may have flexible joints and magnetized material to make it easy to wrap the legs around different surface shapes, such as pipe, column, etc.

The electronic assembly (161c) includes a wide range of components that can generate, store, and display permanent NDT records. The electronic assembly (161c) may also include other components to provide additional features, such as solar/battery power and connection through a mesh network. For example, an NDT record may include all testing parameters and exact defect location identified during NDT. In particular, the electronic assembly (161c) includes the NDT interface (162), smart interface screen (163), biometric device (164a, 164b) including a camera (164a) and a fingerprint scanner (164b), and data storage device (165). The NDT interface (162) includes hardware and software components that control and record NDT testing parameters such as input/output voltage, coating types and thickness, and testing duration. The NDT interface (162) is equipped with a GPS tool for identifying test location coordinates. The NDT interface (162) is also equipped with a data communication module having data connection capability via wired or wireless (e.g., WIFI, Bluetooth, etc.) communicate networks to communicate with the other parts of the NDT inspection system or other equipment in the oil and gas environment (100).

The smart interface screen (163) includes multiple display windows, such as an NDT operator photo window (163a) and NDT interface windows (163b-163g). The NDT operator photo window (163a) is used to display a portrait captured using the camera (164a) of the NDT operator who performs the NDT and other NDT participants such as a witness to the NDT. The NDT interface windows (163b-163g) are used to display and/or receive operator inputs of NDT checklist, NDT encyclopedia (i.e., test equipment, process, and other instructions), NDT result report, GPS coordinates of test location, data communication connectivity, and other related information. For example, the NDT interface window (163b) allows the NDT operator to check off each item as it is completed during the NDT. For verification purposes, the final checklist is stored with the NDT operator's portrait and the video of the NDT operator performing the checklist items. The NDT interface window (163c) allows the NDT operator to look up instructions and commonly asked questions regarding how to perform various aspects of the NDT process. The NDT interface window (163d) allows the NDT operator to request automated generation of NDT report or view the generated NDT report. The NDT interface window (163e) allows the NDT operator to access the GPS functions such as displaying current or historical GPS coordinates. The NDT interface window (163f) allows the NDT operator to configure or otherwise control the data connectivity, such as USB, WIFI, Bluetooth, or SIM module. Additionally, the NDT interface window (163g) provides other functions via a function menu such as allowing the NDT operator to initiate NDT test information recording or display the recorded information. For example, the recorded NDT test information may be stored and retrieved using the data storage device (165).

FIG. 1C illustrates a block diagram of example operations of the NDT inspection system (195) based on the AI system (160) and NDT inspection devices (160b) depicted in FIG. 1A above. In one or more embodiments, one or more of the modules and/or elements shown in FIG. 1C may be omitted, repeated, combined and/or substituted. Accordingly, embodiments disclosed herein should not be considered limited to the specific arrangements of modules and/or elements shown in FIG. 1C.

As shown in FIG. 1C, an NDT test setup (166a) is specified prior to onsite activities, i.e., performing NDT at the NDT site. The NDT test setup (166a) is inputted to the AI system (160) and used as the baseline data to verify aspects of the onsite activities. The NDT test setup (166a) includes information regarding NDT participants (e.g., operator and witness), equipment and process, and anticipated result. During onsite activities, the AI system (160) obtains the recorded NDT test information from the NDT inspection devices (160b) and compares the recorded NDT test information with the NDT test setup (166a) to perform various tasks such as participant verification (166b), equipment & process verification (166c), NDT result verification (166d), and report generation and update (166e). For example, a report (166f) is generated to authenticate fully verified NDT process by utilizing AI algorithms of the AI system (160).

FIG. 1D illustrates a block diagram of example operations of the AI system (160) depicted in FIG. 1A above. In one or more embodiments, one or more of the modules and/or elements shown in FIG. 1D may be omitted, repeated, combined and/or substituted. Accordingly, embodiments disclosed herein should not be considered limited to the specific arrangements of modules and/or elements shown in FIG. 1D.

As shown in FIG. 1D, the AI system (160) includes a supervised learning algorithm (160b) that is trained during the training phase based on historical data (160c), feedback data (160d), and conflict resolution data (160e) with associated AI analysis results (160f). For example, the historical data (160c) includes picture analysis from previous NDT verification pass/fail results, past performance of welder/manufacturer of the equipment-under-test, and lesson learned, pitfalls, and alerts from previous NDT processes. The feedback data (160d) includes NDT participants (technician/operator/witness) feedback on the AI analysis results and data collected from the mirror application. The conflict resolution data (160e) refers to conflicts between the technician/operator's viewpoint and the AI analysis results (160f). Each conflict triggers alerts to be sent to an escalation procedure where a SME (subject matter expert) or supervisor provides final decision and feedback to be included in a report.

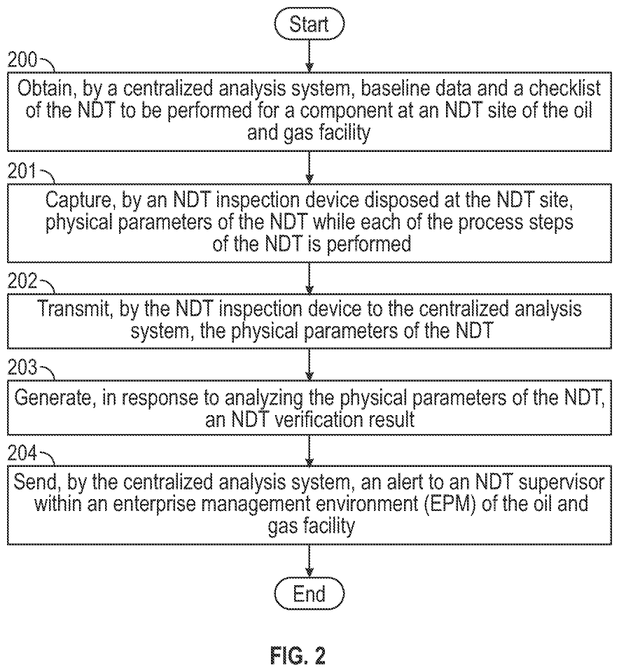

FIG. 2 shows a flowchart in accordance with one or more embodiments disclosed herein. One or more of the steps in FIG. 2 may be performed by the components of the oil and gas environment (100) and the NDT inspection system (160), discussed above in reference to FIGS. 1A-1C. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

Initially in Step 200, baseline data and a checklist are obtained to perform the NDT for a component at an NDT site of the oil and gas facility. In one or more embodiments, the baseline data and a checklist are retrieved by a centralized analysis system from a request for inspection (RFI) of the NDT. In particular, the baseline data includes target parameters of the NDT, such as participant information, equipment information, NDT site information, and time/date of the NDT. The checklist includes process steps of the NDT and time intervals between the process steps. In one or more embodiments, the centralized analysis system includes machine learning (ML) and artificial intelligence (AI) algorithms and is referred to as an AI system. The checklist may be generated by AI algorithms or by the user.

In Step 201, physical parameters of the NDT are captured by an NDT inspection device while each of the process steps of the NDT is performed. Specifically, the NDT inspection device is disposed at the NDT site to monitor the NDT. In one or more embodiments, the physical parameters of the NDT include biometric data of an NDT participant, timestamp and GPS information of the NDT, and images of each of the process steps of the NDT. For example, the biometric data may be captured using a fingerprint scanner of the NDT inspection device, the timestamp and GPS information may be captured using a timer and GPS tool of the NDT inspection device, and the images may be captured using a camera of the NDT inspection device.

In Step 202, the physical parameters of the NDT are transmitted by the NDT inspection device to the centralized analysis system. In one or more embodiments, the NDT inspection device and the centralized analysis system are coupled via a cloud network. In such embodiments, the physical parameters are transmitted using a cloud network interface of the NDT inspection device. For example, each of the physical parameters may be transmitted in real time after being captured. In another example, the physical parameters may be stored in the NDT inspection device and transmitted as a batch.

In Step 203, the physical parameters of the NDT are analyzed by the centralized analysis system with respect to the baseline data and the checklist of the NDT. For example, the analysis may include comparing the biometric data of the NDT participant versus the participant information in the baseline data to verify the correct identity of the NDT operator and/or witness, comparing the timestamp versus the time/date in the baseline data to verify that the requested test is completed on the correct time/date, comparing the GPS information of the NDT versus the NDT site information in the baseline data to verify the correct location and component being tested, comparing the images containing participant's facial pictures versus any photo ID in the baseline data to further verify the correct participant identity, and comparing the images of each process step of the NDT and the equipment information in the baseline data to verify that correct equipment is used to perform the testing.

In Step 204, an NDT verification result is generated in response to analyzing the physical parameters of the NDT by the centralized analysis system. Based on the analysis performed in Step 203 above, the NDT verification result may include one or more pieces of proof/evidence of correctly completing the NDT, proof of correct participants of the NDT, proof of authentic NDT result without alteration, and proof of correct time and location of each of the process steps of the NDT. The NDT verification result may include a boolean value indicating whether the test was successfully completed or not. In alternate embodiments, the verification result may be a detailed report summarizing the physical parameters of the NDT in comparison to the baseline data. The NDT verification result may also include inconsistencies or issues with one or more of: completing the NDT, participants of the NDT, NDT result, and time and location of each of the process steps of the NDT. In one or more embodiments, the NDT verification result is generated by the centralized analysis system. For example, the centralized analysis system may detect an inconsistency or identify an issue in the NDT verification result and generated an alert accordingly.

In Step 205, when the inconsistency or any issue is detected, an alert is sent by the centralized analysis system to an NDT supervisor within an information management system of the oil and gas facility. Accordingly, a corrective action of the NDT is initiated by the NDT supervisor in response to the alert. In one or more embodiments, the centralized analysis system is integrated within the information management system to facilitate sending the alert and initiating the corrective action. For example, the corrective action may include invalidating the NDT associated with the detected inconsistency or issue. Accordingly, a supplemental RFI is sent from the information management system to the NDT inspection system to redo the NDT.

When there are no inconsistencies or issues detected by the NDT device, an alert may not be sent. Rather, the system may send an indication that the process was successful. Alternatively, nothing may be sent to the supervisor.

The purpose of the flowchart of FIG. 2 is to automate the process of NDT to reduce assets lost, frequent inspection survey cost and capital project schedule delay.

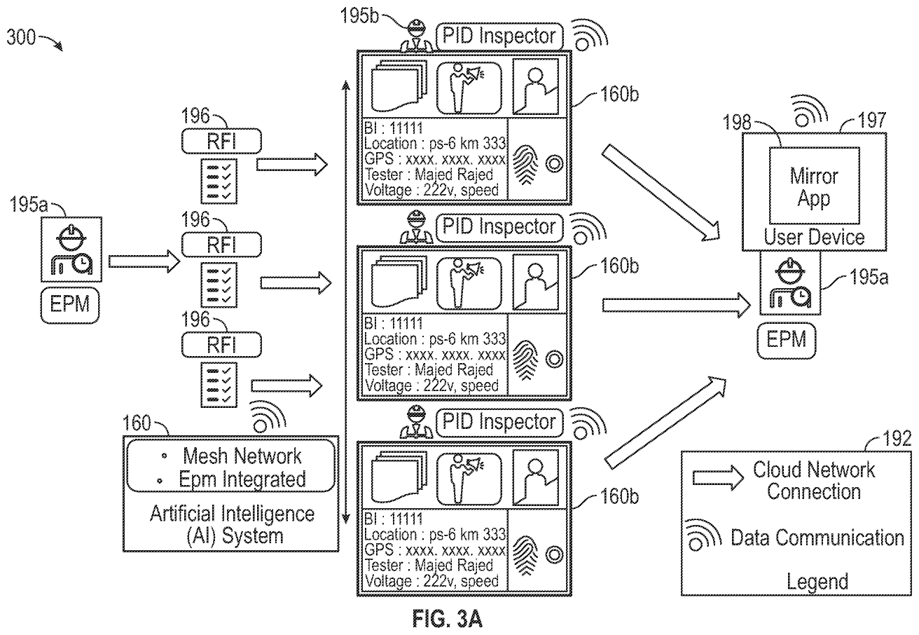

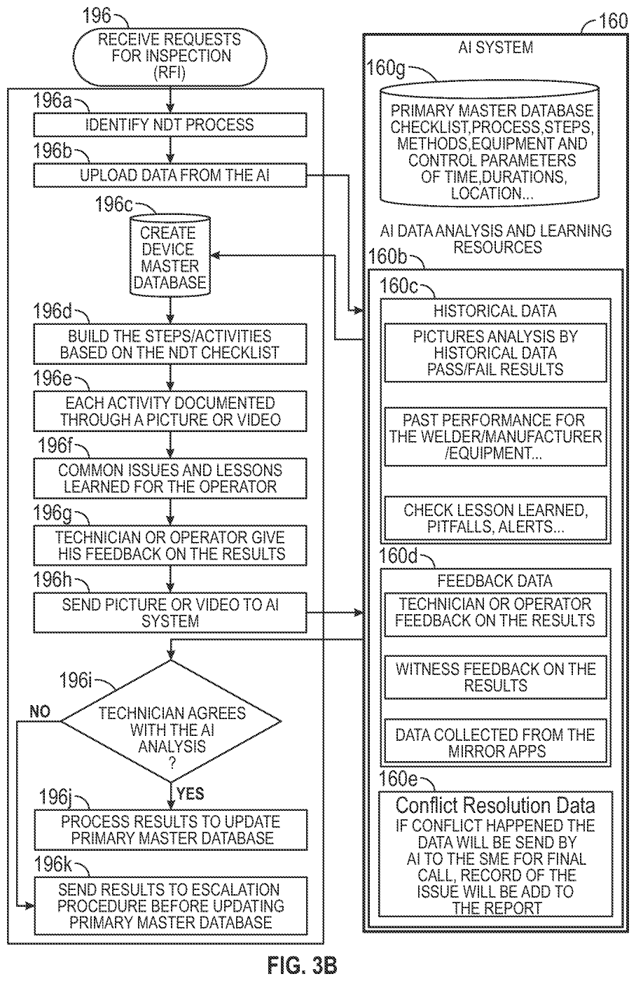

FIGS. 3A-3B illustrate an implementation example of the NDT inspection system depicted in FIG. 1A above. In one or more embodiments, one or more of the modules and/or elements shown in FIGS. 3A-3B may be omitted, repeated, combined and/or substituted. Accordingly, embodiments disclosed herein should not be considered limited to the specific arrangements of modules and/or elements shown in FIGS. 3A-3B.

As shown in FIG. 3A, the NDT inspection devices (160b) are connected through the cloud network connection of the NDT inspection system to the AI system (160) to perform the following operations according to the legend (192). In the example shown in FIG. 3A, the AI system (160) is integrated within an information management system (300), e.g., via a mesh data network of the information management system (300). The network connection is secured and can be updated when it is disconnected. The information management system (300) includes functionalities to facilitate the practice of managing projects on a companywide scale. It generally involves implementing strategies and processes to streamline and improve the effectiveness of project management on the companywide scale, such as throughout the organization or entity operating the facilities in the oil and gas environment (100) depicted in FIG. 1A above.

In the example operations of the NDT inspection system, a request for inspection (RFI) (196) is initiated by an NDT supervisor (195a) and received through Email or data warehouse of the information management system to verify or otherwise witness an NDT activity performed by an NDT operator (195b). Through the integration with the EMP environment (300), the AI system (160) is notified of or otherwise obtains each RFI (196) to analyze the request and generate the following baseline data that includes target parameters of the NDT:
(1) Project Info;
(2) Who will do the test and check from the list of approve inspector/operator's database (if activated/available) if he is approved for this type of test;
(3) Set work location using GPS;
(4) Time & date of the test;
(5) Who needs to be notified with the NDT result data to receive the Preliminary & final reports;
(6) What NDT test is requested;
(7) General Information of the planned NDT;
(8) Utilize or build the NDT checklist with the required steps and the time between steps;
(9) Check the Database for Lesson Learn to update the checklist; and
(10) List of the approved equipment for the planned NDT.

The checklist can be generated by AI algorithms or by the user. The AI system (160) monitors and verifies any user specified a set of approved tools or equipment is used as a check point before starting the NDT activity and during the NDT activity such that the verification is added to the final report.

During the NDT process, videos and photos are captured using the NDT inspection device (160b) at the NDT site and transmitted to the AI system (160). The AI system (160) monitors the implementation of the NDT checklist steps by analyzing the captured videos and photos using AI algorithms to verify the following:
(1) Who did the work of each checklist step;
(2) Who attended as witness to the NDT process;
(3) Fingerprint scanner output;
(4) Physical IDs of NDT participants (e.g., JCC, Government issued cards);
(5) Time and GPS information; and
(6) Time between completing successive NDT checklist steps.

During the NDT process, each of multiple NDT participants (e.g., NDT operator, witness, etc.) uses his/her own NDT inspection device (160b) to record NDT test information. The NDT test information recorded on each NDT inspection device (160b) is referred to a view point of a corresponding participant. AI algorithms are utilized to compare multiple NDT participants' viewpoints as captured by, for example, a mirror application (Mirror App) (198). In one or more embodiments, the Mirror App (198) is used by the AI system and the supervisor to verify and monitor the NDT operator and the NDT process, to clarify issues from SMEs, and to use as training tools for new employees or operator trainees. The Mirror App (198) can be used for the supervisor to supervise the NDT implementation, to obtain advice from an SME, and to have NDT records reviewed at a subsequent time/date as a proof of complete action. The Mirror App (198) can also allow a client of the industrial facility to watch the ongoing work during NDT implementation. The Mirror App (198) can also send the NDT verification results and any detected issues to an additional pre-approved monitor without using the operator/technician interface. The Mirror App (198) is a software application that can be installed on a user device (197), such as smart phones or web based for personal computers of an NDT witness or supervisor to monitor and collect extra data for the NDT inspection system with the following functions:
(I) Encrypted data connection for other NDT participants (e.g., witnesses) to see the ongoing steps and completed steps which is available on an NDT inspection device (160b) or the cloud network. A user can view the information via a QR code generated by the NDT inspection device;
(II) Communication link to request and receive advice at the NDT site from a remote consultant;
(III) Capture data from different Mirror Apps installed on the smart phones of the witnesses and compare the Mirror App captured data with the physical parameter data captured by the NDT inspection devices; and
(IV) Use by the witnesses to confirm what they saw and to sign off the verification result.

Those skilled in the art will appreciate that the mirror application is one example, and that any suitable smart phone application may be utilized for the purpose described above (i.e., as input into the AI algorithm).

AI algorithms are utilized to analyze captured results (i.e., photos, videos, NDT test input/output) in each checklist step for comparing against the baseline data and historical data to warn/alert the NDT operator on any inconsistencies (Pass/Fail) or identified issues. The detected inconsistencies and identified issues in each NDT checklist step trigger automated alarm notifications to be sent to end users of the information management system, such as the NDT supervisor (195a).

AI algorithms are utilized to generate preliminary and final NDT inspection reports that are sent via the cloud network (190) to the pre-approved distribution list as setup in the baseline data. The preliminary and final NDT inspection reports may include a postmortem analysis of “lesson learned” to be distributed via the cloud network (190).

FIG. 3B illustrates an internal workflow of the NDT inspection device initiated by the RFI (196) and interacting with the AI system (160). As shown in FIG. 3B, upon receiving the RFI (196), the NDT inspection device (160b) identifies the NDT process (Step 196a), upload NDT data from the primary master database (160g) of the AI system (160) (Step 196b) to create the device master data base (Step 196c) that is used to build the NDT processes/activities (Step 196d). Accordingly, the operator performs each NDT process/activity while using the NDT inspection device (160b) to document each step by capturing picture or video (Step 196e) and record any issue and lesson learned (Step 196f) as well as feedback on the NDT results (Step 196g). The NDT inspection device (160b) sends the NDT test data such as the captured picture/video to the AI system (160) for analysis using the supervised learning algorithm (160b). As previously described in FIG. 1D, the supervised learning algorithm (160b) is trained based on the historical data (160c), feedback data (160d), and conflict resolution data (160e) shown in FIG. 1C above. The AI system analysis result is then sent to the NDT inspection device (160b) to compare with the NDT technician/operator's view point (Step 196i). If the comparison indicates that the technician agrees with the AI analysis result, the result is processed to update the primary master database (160g) (Step 196j). If the comparison indicates that the technician disagrees with the AI analysis result, the result is sent to an escalation procedure before being processed to update the primary master database (160g). In the escalation procedure, a SME or supervisor reviews the AI analysis results and the NDT technician/operator's view point to finalize the NDT inspection pass/fail determination (Step 196k).

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method to perform a nondestructive test (NDT) of an industrial facility, comprising:
obtaining, by a centralized analysis system, baseline data and a checklist of the NDT to be performed for a component at an NDT site of the industrial facility, wherein the baseline data comprises target parameters of the NDT, wherein the checklist comprises process steps of the NDT;
capturing, by an NDT inspection device disposed at the NDT site, physical parameters of the NDT while each of the process steps of the NDT is performed;
transmitting, by the NDT inspection device to the centralized analysis system, the physical parameters of the NDT;
analyzing, by the centralized analysis system, the physical parameters of the NDT with respect to the baseline data and the checklist of the NDT; and
generating, in response to said analyzing by the centralized analysis system, an NDT verification result.

2. The method of claim 1,
wherein the target parameters of the NDT comprises participant information of the NDT, equipment information of the NDT, NDT site information, and time/date of the NDT, and
wherein the checklist further comprises time intervals between the process steps of the NDT.

3. The method of claim 1,
wherein the physical parameters of the NDT comprises biometric data of an NDT participant, timestamp and GPS information of the NDT, and images of each

4. The method of claim 1,
wherein the NDT verification result comprises proof of completing the NDT, proof of participants of the NDT, proof of NDT result, and proof of time and location of each of the process steps of the NDT.

5. The method of claim 1, further comprising:
detecting, by the centralized analysis system, an inconsistency or identified issue in the NDT verification result; and
generating, in response to said detecting by the centralized analysis system, an alert.

6. The method of claim 5, further comprising:
sending, by the centralized analysis system according to an escalation procedure, the alert to an NDT supervisor within an information management system of the industrial facility; and
initiating, in response to the alert and by the NDT supervisor, a corrective action of the NDT,
wherein the centralized analysis system is integrated within the information management system.

7. The method of claim 6, further comprising:
receiving, by the centralized analysis system, a request for inspection (RFI) of the NDT,
wherein the RFI comprises the baseline data of the NDT.

8. A nondestructive test (NDT) inspection device for performing an NDT of an industrial facility, comprising:
a plurality of sensors that capture physical parameters of the NDT while each of process steps of the NDT is performed for a component at an NDT site of the industrial facility;
an NDT interface that controls and records NDT testing parameters of the NDT, wherein the NDT interface comprises a GPS tool for locating the NDT site and a data communication module for transmitting the captured physical parameters of the NDT to a centralized analysis system of the industrial facility; and
a display screen that displays the captured physical parameters, a checklist of the NDT, NDT results, GPS information of the NDT site, and a function menu that allows a user to view and check off each of the process steps of the checklist, initiate NDT information recording, and display recorded NDT information,
wherein the centralized analysis system
obtains baseline data and the checklist of the NDT, wherein the baseline data comprises target parameters of the NDT, wherein the checklist comprises the process steps of the NDT,
analyzes the physical parameters of the NDT with respect to the baseline data and the checklist of the NDT, and
generates, in response to analyzing the physical parameters of the NDT, an NDT verification result.

9. The NDT inspection device of claim 8,
wherein the target parameters of the NDT comprises participant information of the NDT, equipment information of the NDT, NDT site information, and time/date of the NDT, and
wherein the checklist further comprises time intervals between the process steps of the NDT.

10. The NDT inspection device of claim 8,
wherein the physical parameters of the NDT comprises biometric data of an NDT participant, timestamp and GPS information of the NDT, and images of each

11. The NDT inspection device of claim 8,
wherein the NDT verification result comprises proof of completing the NDT, proof of participants of the NDT, proof of NDT result, and proof of time and location of each of the process steps of the NDT.

12. The NDT inspection device of claim 8, wherein the centralized analysis system detects an inconsistency or identified issue in the NDT verification result; and generates, in response to detecting the inconsistency or identified issue, an alert.

13. The NDT inspection device of claim 12,
wherein the centralized analysis system sends the alert according to an escalation procedure to an NDT supervisor within an information management system of the industrial facility,
wherein the NDT supervisor initiates, in response to the alert, a corrective action of the NDT, and
wherein the centralized analysis system is integrated within the information management system.

14. The NDT inspection device of claim 13,
wherein the centralized analysis system receives a request for inspection (RFI) of the NDT, and
wherein the RFI comprises the baseline data of the NDT.

15. A nondestructive test (NDT) inspection system for performing an NDT of an industrial facility, comprising:
an NDT inspection device comprising:
a plurality of sensors that capture physical parameters of the NDT while each of process steps of the NDT is performed for a component at an NDT site of the industrial facility;
an NDT interface that controls and records NDT testing parameters of the NDT, wherein the NDT interface comprises a GPS tool for locating the NDT site and a data communication module for transmitting the captured physical parameters of the NDT to a centralized analysis system of the industrial facility; and
a display screen that displays the captured physical parameters, a checklist of the NDT, NDT results, GPS information of the NDT site, and a function menu that allows a user to view and check off each of the process steps of the checklist, initiate NDT information recording, and display recorded NDT information; and
a centralized analysis system that
obtains baseline data and the checklist of the NDT, wherein the baseline data comprises target parameters of the NDT, wherein the checklist comprises the process steps of the NDT,
analyzes the physical parameters of the NDT with respect to the baseline data and the checklist of the NDT, and
generates, in response to analyzing the physical parameters of the NDT, an NDT verification result.

16. The NDT inspection system of claim 15,
wherein the target parameters of the NDT comprises participant information of the NDT, equipment information of the NDT, NDT site information, and time/date of the NDT, and
wherein the checklist further comprises time intervals between the process steps of the NDT.

17. The NDT inspection system of claim 15,
wherein the physical parameters of the NDT comprises biometric data of an NDT participant, timestamp and GPS information of the NDT, and images of each of the process steps of the NDT.

18. The NDT inspection system of claim 15,
wherein the NDT verification result comprises proof of completing the NDT, proof of participants of the NDT, proof of NDT result, and proof of time and location of each of the process steps of the NDT.

19. The NDT inspection system of claim 15,
wherein the centralized analysis system
detects an inconsistency or identified issue in the NDT verification result;
generates, in response to detecting the inconsistency or identified issue, an alert;
obtaining, from an NDT participant, feedback regarding the NDT; and
generates, in response to obtaining the feedback, a lesson learned and best practice of the NDT.

20. The NDT inspection system of claim 19,
wherein the centralized analysis system sends the NDT verification result and the alert according to an escalation procedure to an NDT supervisor within an information management system of the industrial facility,
wherein the NDT supervisor initiates, using a mirror application and in response to the alert, a corrective action of the NDT to facilitate the NDT or to train a new NDT participant, and
wherein the centralized analysis system is integrated within the information management system.
